(19) United States
(12) Patent Application Publication
(10) Pub. No.: US 2017/0273107 A1
(43) Pub. Date: Sep. 21, 2017

(54) BACK-OFF TECHNIQUES FOR NETWORK LISTEN (NL) AT A BASE STATION

(71) Applicant: QUALCOMM Incorporated, San Diego, CA (US)

(72) Inventors: Mostafa KHOSHNEVISAN, San Diego, CA (US); Mehmet YAVUZ, San Diego, CA (US); Yeliz TOKGOZ, San Diego, CA (US)

(21) Appl. No.: 15/073,316

(22) Filed: Mar. 17, 2016

(51) Int. Cl. H04W 74/08

(52) U.S. Cl. CPC H04W 74/085

(57) ABSTRACT

The present disclosure describes a method and an apparatus for communicating during a network listen (NL) mode at a base station. For example, a method is provided for communicating during a network listen (NL) mode at a base station. The example method may include generating a first random number during a first time slot of the NL mode and setting a value of a counter at the base station to the random number generated at the base station. A determination is made whether the base station detects at least one new neighbor base station during the first time slot and the value of the counter is decreased when at least one new neighbor base station is detected during the first time slot. The base station transmits a signal during the first time slot when the value of the counter is determined to be zero.

### INTRODUCTION

The present disclosure relates generally to communication systems, and more particularly, to a base station in a network listen (NL) mode.

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A base station or a cell may be configured to enter network listen (NL) mode for, e.g., reference signal received power (RSRP)/reference signal received quality (RSRQ) measurements, path-lass estimations, determination of cell identifiers, closed subscriber group (CSG) status, and/or decoding of system information of neighbor base stations or cells. However, when more than one base station starts transmitting in the NL mode, the transmissions from one base station may collide with transmissions from other base stations transmitting at the same time. This may result in a base station notable detect all the neighbor base stations due to collisions/interference.

However, the detection of neighbor cells by cell_1 may be improved (e.g., enhanced) if the cells can transmit one at a time and the other cells are listening (e.g., in a listen mode). In an aspect, this can be achieved via a distributed procedure using a back-off mechanism at the cells. A wireless communication network may include a number of eNodeBs that can support communication for a number of user equipments (UEs). A UE may communicate with an eNodeB via the downlink and uplink. The downlink (or forward link) refers to the communication link from the eNodeB to the UE, and the uplink (or reverse link) refers to the communication link from the UE to the eNodeB.

Therefore, there is a desire to reduce collisions between the transmissions of various base stations and/or to improve detection of neighbor base stations.

### BRIEF DESCRIPTION OF THE DRAWINGS

In order to facilitate a fuller understanding of the present disclosure, reference is now made to the accompanying drawings, in which like elements are referenced with like numerals. These drawings should not be construed as limiting the present disclosure, but are intended to be illustrative only.

FIG. 1 is a block diagram conceptually illustrating an example of a wireless communications system, in accordance with an aspect of the present disclosure.

FIG. 2 is a block diagram conceptually illustrating an example of a network architecture, in accordance with an aspect of the present disclosure.

FIG. 3 is a flowchart illustrating a method for transmitting during a network listen (NL) mode at a base station.

FIG. 4 illustrates an example system 400 for transmitting during a network listen (NL) mode at a base station.

FIG. 5 is a block diagram conceptually illustrating an example of a telecommunications system, including aspects of the system of FIG. 1.

FIG. 6 is a conceptual diagram illustrating an example of an access network for use with a UE, in accordance with an aspect of the present disclosure.

FIG. 7 is a conceptual diagram illustrating an example of a radio protocol architecture for the user and control planes for a base station and/or a UE, in accordance with an aspect of the present disclosure

FIG. 8 is a block diagram conceptually illustrating examples of an eNodeB and a UE configured in accordance with an aspect of the present disclosure.

FIG. 9 is a block diagram conceptually illustrating an example hardware implementation for an apparatus employing a processing system configured in accordance with an aspect of the present disclosure.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to one example, a method for communicating during a network listen (NL) mode at a base station is provided. The method includes generating a first random number at the base station during a first time slot of the NL mode, setting a value of a counter to the first random number, determining whether the base station detects at least one new neighbor base station during the first time slot of the plurality of time slots, decreasing the value of the counter by one in response to determining that the base station did not detect at least one new neighbor base station during the first time slot of the plurality of time slots, determining whether the value of the counter is zero, and transmitting a signal by the station during the first time slot when the value of the counter is determined to be zero.

In another example, an apparatus for communicating during a network listen (NL) mode at a base station is provided. The apparatus includes means for generating a first random number at the base station during a first time slot of the NL mode, means for setting a value of a counter to the first random number, means for determining whether the base station detects at least one new neighbor base station during the first time slot of the plurality of time slots, means for decreasing the value of the counter by one in response to determining that the base station did not detect at least one new neighbor base station during the first time slot of the plurality of time slots, means for determining whether the value of the counter is zero, and means for transmitting a signal by the station during the first time slot when the value of the counter is determined to be zero.

In a further example, a non-transitory computer readable medium storing computer executable code for communicating during a network listen (NL) mode at a base station is provided. The non-transitory computer readable medium includes code for generating a first random number at the base station during a first time slot of the NL mode, setting a value of a counter to the first random number, determining whether the base station detects at least one new neighbor base station during the first time slot of the plurality of time slots, decreasing the value of the counter by one in response to determining that the base station did not detect at least one new neighbor base station during the first time slot of the plurality of time slots, determining whether the value of the counter is zero, and transmitting a signal by the station during the first time slot when the value of the counter is determined to be zero.

Additionally, in another example, a base station for communicating during a network listen (NL) mode is provided. The base station includes a memory configured to store data and one or more processors communicatively coupled with the memory. The one or more processors and the memory are configured to generate a first random number at the base station during a first time slot of the NL mode, set a value of a counter to the first random number, determine whether the base station detects at least one new neighbor base station during the first time slot of the plurality of time slots, decrease the value of the counter by one in response to determining that the base station did not detect at least one new neighbor base station during the first time slot of the plurality of time slots, determine whether the value of the counter is zero, and transmit a signal by the station during the first time slot when the value of the counter is determined to be zero.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

A small cell or a small cell base station or access point may refer, but is not limited to, a femtocell, picocell, microcell, or any other cell or base station having a relatively small transmit power or relatively small coverage area as compared to a macro cell or macro base station. The techniques described herein may be used for various wireless communication networks such as CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). 3GPP LTE and LTE-Advanced (LTE-A) are new releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, certain aspects of the techniques are described below for LTE, and LTE terminology is used in much of the description below.

Small cell base stations may include a Network Listen (NL) module that includes some mobile-station-like capabilities that allow the NL module to detect downlink control signals from a neighboring base station having a coverage area in which the small cell base station is located. The NL module can be configured to receive Over-the-Air (OTA) signals from neighboring base stations. The NL module can be configured to listen for and decode the OTA signals transmitted by neighboring base stations to obtain relevant information from one or more networks proximate to the base station that includes the NL module. The NL module can be configured to enable the base station to execute applications, including, but not limited to: (a) self-organizing network (SON) related applications, such as building a neighbor list, physical cell identity (PCI) selection to avoid PCI collisions with neighboring cells; (b) approximate location determination using cell global identity (CGI) of neighboring base stations; (c) time and frequency synchronization; and (d) interference management. The NL module of a small cell base station can be configured to listen for OTA signals from a neighboring base station and can be configured to use these signals from neighboring base station, such as a macrocell base station or even another small cell base station. With respect to time and frequency synchronization, the NL listen module can enable a small cell base station to correct for timing and/or frequency synchronizations at the small cell.

Some conventional base stations are configured to advertise the synchronization capability of the base station in terms of a relative ranking, referred to as a synchronization stratum. A small cell base station that includes a NL module can determine whether a neighboring base station has a tighter synchronization capability than the small cell base station based on the synchronization capability information advertised by the neighboring base station. Base stations having a lower stratum level, which implies that the base station has looser synchronization accuracy, can be configured to listen to control signals from base stations advertising a higher stratum level, and thus, tighter synchronization accuracy. The NL module of a small cell base station can thus be configured to select a neighboring base station advertising a higher stratum level.

For example, a small cell base station may have a neighboring pico cell, a neighboring macrocell base station, and a neighboring femto cell from which the small cell base station from which the small cell base station could obtain synchronization information. Macrocell base stations and pico cells typically have tighter synchronization requirements than a femto cell, and may advertise be associated with a higher synchronization stratum level than the femto cell. However, in some femto cell implementations may have a higher synchronization level. For example, some femto cells may be configured to derive synchronization from reliable external sources, such as a Global Navigation Satellite System (GNSS) including the Global Positioning System (GPS) or from a network server using Precision Timing Protocol (PTP). Accordingly, a femto cell (or other small cell base station) may be associated with a high stratum level.

A mechanism for communicating during a network listen (NL) mode at a base station is disclosed. For example, a base station may be configured to set a value of a counter at the base station to a first random number generated during a first time slot. The random number may be generated based on the size of the contention window at the base station. The base station then determines whether at least one new neighbor base station is detected during the first time slot and decreases the value of the counter by one when the base station does not detect any new neighbor base stations during the first time slot. The base station then transmits a signal during the first time slot of the NL mode when the value of the counter is determined to be zero.

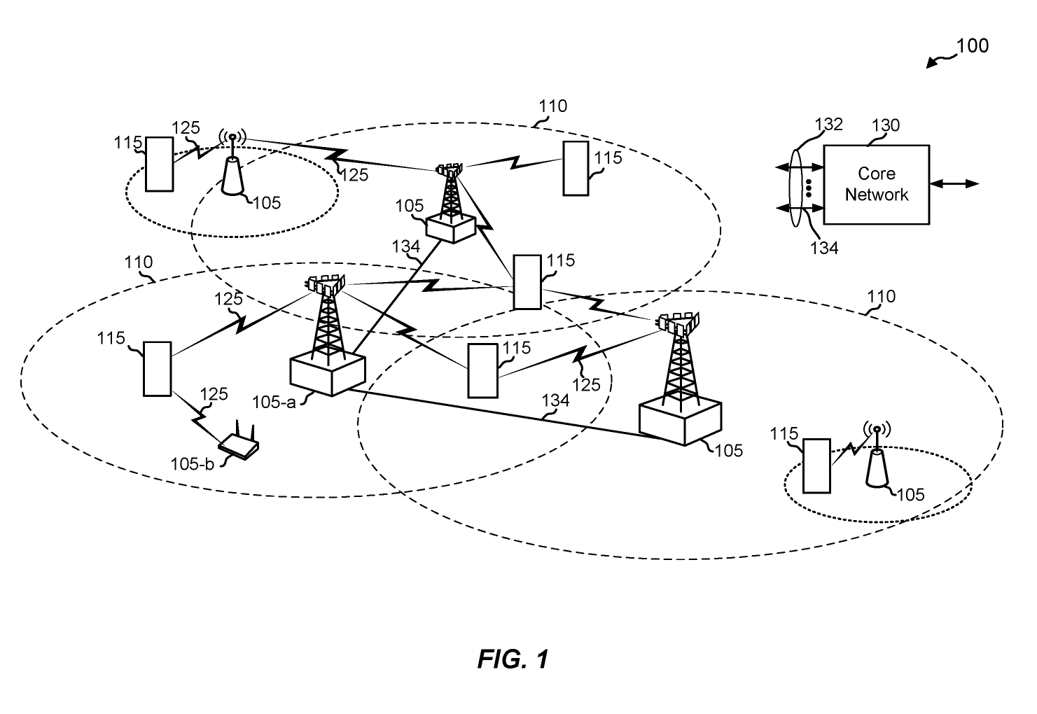

FIG. 1 is a block diagram conceptually illustrating an example of a wireless communications system 100, in accordance with an aspect of the present disclosure. The wireless communications system 100 includes base stations (or cells) 105, user equipment (UEs) 115, and a core network 130. The base stations 105 may communicate with the UEs 115 under the control of a base station controller (not shown), which may be part of the core network 130 or the base stations 105 in various aspects. The base stations 105 may communicate control information and/or user data with the core network 130 through first backhaul links 132. In aspects, the base stations 105 may communicate, either directly or indirectly, with each other over second backhaul links 134, which may be wired or wireless communication links. The wireless communications system 100 may support operation on multiple carriers (waveform signals of different frequencies). Multi-carrier transmitters can transmit modulated signals simultaneously on the multiple carriers. For example, each communication link 125 may be a multi-carrier signal modulated according to the various radio technologies described above. Each modulated signal may be sent on a different carrier and may carry control information (e.g., reference signals, control channels, etc.), overhead information, data, etc. The wireless communications system 100 may also support operation on multiple flows at the same time (e.g., cellular and Wi-Fi or wireless local area networks (WLANs)).

The base stations 105 may wirelessly communicate with the UEs 115 via one or more base station antennas. Each of the base stations 105 sites may provide communication coverage for a respective geographic coverage area 110. In some aspects, base stations 105 may be referred to as a base transceiver station, a radio base station, an access point, a radio transceiver, a basic service set (BSS), an extended service set (ESS), a NodeB, eNodeB, Home NodeB, a Home eNodeB, or some other suitable terminology. The geographic coverage area 110 for a base station 105 may be divided into sectors making up only a portion of the coverage area (not shown). The wireless communications system 100 may include base stations 105 of different types (e.g., macro, micro, and/or small base stations). There may be overlapping coverage areas for different technologies.

In aspects, the wireless communications system 100 is an LTE/LTE-A network communication system. In LTE/LTE-A network communication systems, the terms evolved NodeB (eNodeB) may be generally used to describe the base stations 105. The wireless communications system 100 may be a Heterogeneous LTE/LTE-A network in which different types of eNodeBs provide coverage for various geographical regions. For example, each eNodeB 105 may provide communication coverage for a macro cell, a small cell, and/or other types of cells. A macro cell generally covers a relatively large geographic area (e.g., several kilometers in radius) and may allow unrestricted access by UEs 115 with service subscriptions with the network provider. A small cell would generally cover a relatively smaller geographic area (e.g., buildings, home, etc.) and may allow unrestricted access (e.g. buildings, etc.) by UEs 115 with service subscriptions with the network provider and/or restricted access (e.g., home, etc.) by UEs 115 having an association with the small cell (e.g., UEs 115 in a closed subscriber group (CSG), UEs 115 for users in the home, and the like). An eNodeB 105 for a macro cell may be referred to as a macro eNodeB. An eNodeB 105 for a small cell may be referred to as a home eNodeB. An eNodeB 105 may support one or multiple (e.g., two, three, four, and the like) cells. The wireless communications system 100 may support use of LTE and WLAN or Wi-Fi by one or more of the UEs 115. A small cell may refer to a micro cell, a pico cell, or a femto cell, for example.

The core network 130 may communicate with the eNodeBs 105 or other base stations 105 via first backhaul links 132 (e.g., S1 interface, etc.). The eNodeBs 105 may also communicate with one another, e.g., directly or indirectly via second backhaul links 134 (e.g., X2 interface, etc.) and/or via the first backhaul links 132 (e.g., through core network 130). The wireless communications system 100 may support synchronous or asynchronous operation. For synchronous operation, the eNodeBs 105 may have similar frame timing, and transmissions from different eNodeBs 105 may be approximately aligned in time. For asynchronous operation, the eNodeBs 105 may have different frame timing, and transmissions from different eNodeBs 105 may not be aligned in time. The techniques described herein may be used for either synchronous or asynchronous operations.

The UEs 115 may be dispersed throughout the wireless communications system 100, and each UE 115 may be stationary or mobile. A UE 115 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a personal digital assistant (PDA), a wireless modem, a wireless communication device, a handheld device, a tablet computer, a laptop computer, a cordless phone, a wireless local loop (WLL) station, a wireless network appliance (e.g., devices for Internet of Things (IoT)), or the like. A UE 115 may be able to communicate with macro eNodeBs, pico eNodeBs, femto eNodeBs, relays, and the like.

The communication links 125 shown in the wireless communications system 100 may include uplink (UL) transmissions from a UE 115 to an eNodeB 105, and/or downlink (DL) transmissions, from an eNodeB 105 to a UE 115. The downlink transmissions may also be called forward link transmissions while the uplink transmissions may also be called reverse link transmissions.

In certain examples, an eNodeB 105 may correspond to a cell and may be configured to perform a distributed mechanism for communicating during a network listen (NL) mode at a base station. The distributed mechanism decreases the chance of collision with transmissions from neighbor base station and increases the chance of detecting transmissions from the neighbor base stations. For example, in an aspect, a counter at the base station may be set to a random value generated at the base station. The random value may be generated based on the size of the contention window at the base station. The base station then listens for transmissions from neighbor base station and decreases the value of the counter by one if the base station detects transmissions from any new neighbor base stations. The base station then checks if the value of the counter is zero and transmits if the value of the counter is determined to be zero. This approach allows the base stations to transmit during different slots of a contention window for reducing collisions between transmissions of neighbor base stations and/or improve detection of transmissions from neighbor base stations.

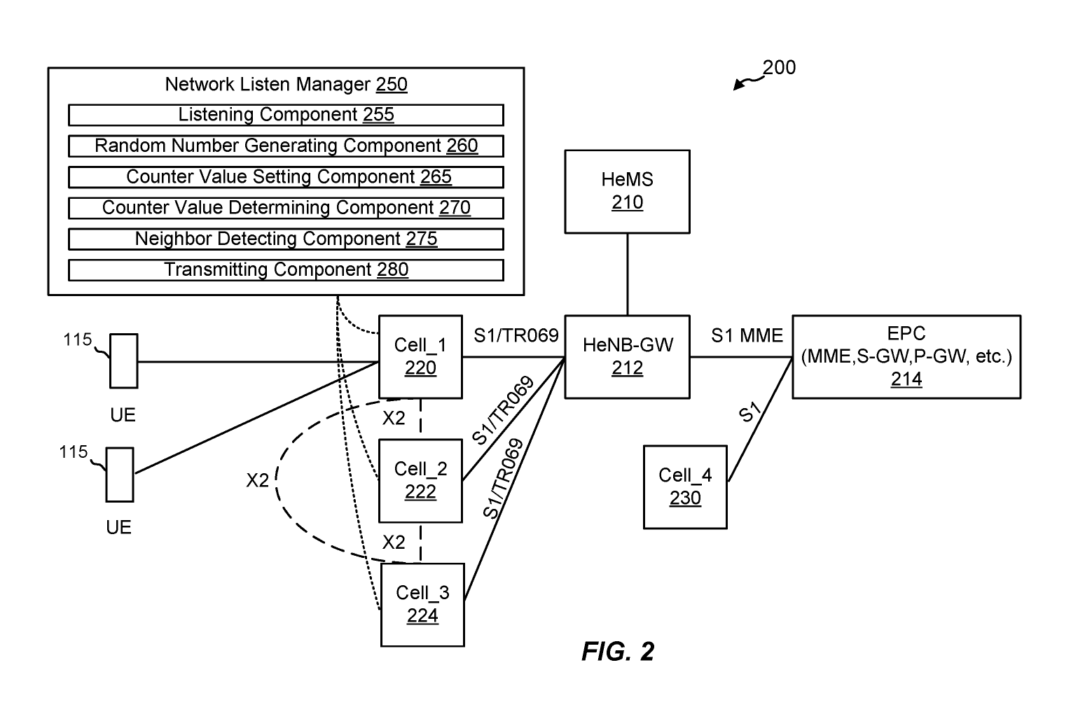

FIG. 2 is a block diagram conceptually illustrating an example of a network 200, in accordance with an aspect of the present disclosure. The network 200 may be part of the wireless communications system 100 of FIG. 1, and may include a home eNodeB management system (HeMS 210) capable of handling operation, administration, and management (OAM) for small cell base stations in a home network. The network 200 may also include a home eNodeB gateway (HeNB-GW) 212, an evolved packet core (EPC) 214, and multiple cells, including macro cells and/or small cells. For example, in an aspect, network 200 may include small cells (e.g., cell_1 220, cell_2 222, an/or cell_3 224 in communication with the HeNB-GW 212 via S1/TR069 interface, and/or macro cells (e.g., cell_4 230 in communication with EPC 214 via an S1 interface, and UEs 115 in communication with cell_1. The HeNB-GW 212 and the EPC 214 may communicate via an S1 mobility management entity (MME) interface. The cells of FIG. 2 may correspond to some of the base stations (or cells) described above with respect to FIG. 1.

A cell may enter network listen (NL) mode upon initial system setup/configuration, periodically after the initial system setup/configuration, and/or as needed. In an aspect, cells 220, 222, 224, and/or 230 (i.e., cell_1, cell_2, cell_3, and/or cell_4) may be configured to enter network listen (NL) mode, for example, for reference signal received power (RSRP)/reference signal received quality (RSRQ) measurements, path-lass estimations, determination of cell identifiers, closed subscriber group (CSG) status, and/or decoding of system information of neighbor base stations or cells. However, when more than one cell starts transmitting in the NL mode, the transmissions from one cell may collide with transmissions from other cells transmitting at the same time. This may result in a cell (e.g., cell_1) not be able detect all the neighbor base stations (e.g., cell_2, cell_3, etc.) due to collisions/interference. However, the detection of neighbor cells by cell_1 may be improved (e.g., enhanced) if the cells can transmit one at a time and the other cells are listening (e.g., in a listen mode). In an aspect, this can be achieved via a distributed procedure using a back-off mechanism at the cells.

The proposed techniques configure a base station (e.g., cell_1) with a NL manager 250 which may be configured to set a value of a counter at the base station to the first random number generated during a first time slot at the base station, determine whether the base station detects at least one new neighbor base station during the first time slot of the plurality of time slots, decrease the value of the counter by one when the base station does not detect any new neighbor base stations during the first time slot, and transmitting during the first time slot when the value of the counter is determined to be zero.

In an aspect, NL manager 250 may configured to include a random number generating component 260, a counter value setting component 265, a counter value determining component 270, a neighbor detecting component 275, and/or a transmitting component 280 for transmitting during a network listen (NL) mode at a base station.

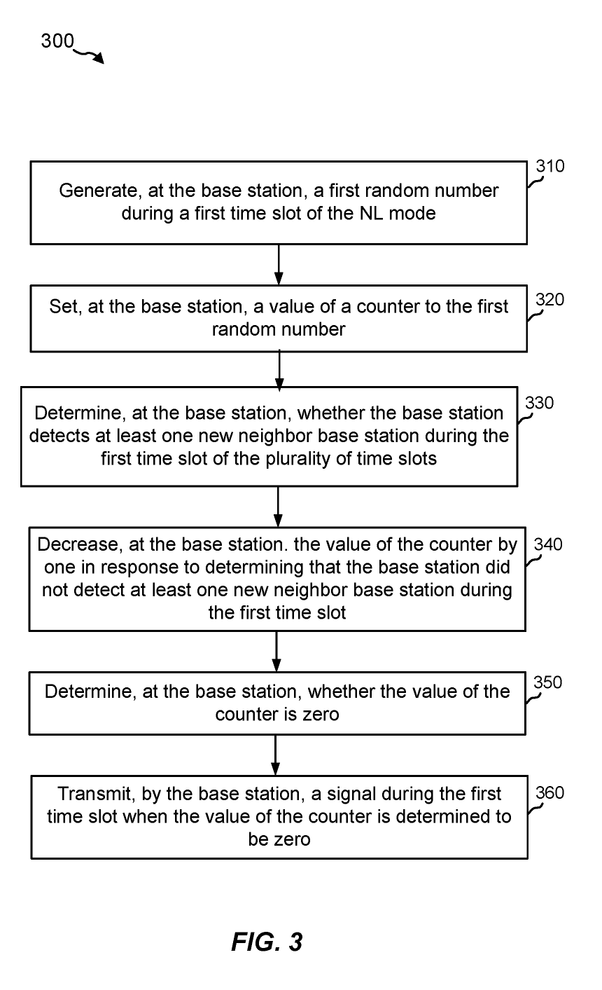

FIG. 3 is a flowchart illustrating a method 300 for communicating during a network listen (NL) mode at a base station.

In an aspect, at block 310, methodology 300 may include generating, at the base station, a first random number during a first time slot of the NL mode at the base station, wherein the generation of the first random number is based at least on a size of a contention window which includes a plurality of time slots. For example, in an aspect cell_1 220 and/or NL manager 250 may include a specially programmed processor module, or a processor executing specially programmed code stored in a memory, to generate a first random number at the base station (e.g., cell_1 220) during a first time slot of the NL mode, wherein the generation of the first random number is based at least on a size of a contention window which includes a plurality of time slots. In an aspect, listening component 255 is aware of the NL period and may communicate to the base station (e.g., cell_1 220) and/or NL manager 250 when the NL period is initiated at the base station to generate a first random number at the base station. In an additional aspect, cell_1 220 and/or NL Manager 250 may include a random number generating component 260 to perform this function based on communication with the listening component 255.

For instance, network listen (NL) mode at a base station refers to a base station entering a state for monitoring its surrounding RF environment (e.g., neighbor base stations) using a module at the base station, e.g., network listen module (NLM), a sniffer, etc. The surrounding RF environment may be transmissions from neighbor base stations or UEs. In wireless networks, especially small cell deployments, each cell may perform RF measurements of other cells' pilot channels and determine their transmit power level. The measurements may be performed at initial set-up, initial power-up or subsequent power-up, and may be repeated periodically to monitor any changes in the RF environment. In an aspect, the NL mechanism may be used with small cells which are controlled by a centralized network entity (such as an OA&M system, e.g. a HeMS 210) for centralized network optimization or locally at the small cells for auto-configuration purposes.

For instance, in an aspect, a random number generator at a base station (e.g., cell_1 220) may be used to generate a first random number at the base station when the base station is in the NL mode. The random number generator may be hardware or software, and may reside at the base station, e.g., in the NL manager 250. Additionally, the size of the contention window may correspond to a time interval for waiting in the NL mode prior to transmission by a base station to avoid collisions with transmissions from other base stations. In an aspect, the size of the contention window may be expressed in units of time slots (TS). For example, the size of contention window may be configured for, e.g., 20 time slots, 50 time slots, etc. and/or the time slot may be configured for 1 ms. In an example aspect, the size of the contention window may be configured to twenty or fifty time slots by a network operator.

In an aspect, cell_1 220 may generate a first random number using the random number generator. The random number generated may be based on the size of the contention window configured at the base station. For instance, if the size of contention window is configured to a value of a 20 time slots, cell_1 220 and/or NL manager 250 may generate a random number between 1 and 20. In an additional or optional aspect, cell_2 222, cell_3 224, and/or cell_4 230 may be also configured with an instance of NL manager 250 that may configured to generate a random number (e.g., a first random number) during the first time slot.

In an aspect, at block 320, methodology 300 may include setting, at the base station, a value of a counter to the first random number. For example, in an aspect cell_1 220 and/or NL manager 250 may include a specially programmed processor module, or a processor executing specially programmed code stored in a memory, to set a value of a counter at the base station to the first random number. In an aspect, the base station (e.g., cell_1 220) and/or NL Manager 250 may include a counter value setting component 265 to perform this function.

For instance, in an aspect, cell_1 220 and/or NL manager 250 may initiate a counter at the cell (e.g., cell_1 220) and set the value of the counter to the first random number generated at cell_1 220. As described above, the first random number may have been generated by a random number generator at cell_1 220. In an example aspect, the counter at cell_1 220 may be set to a value of a twenty.

In an aspect, at block 330, methodology 300 may include determining, at the base station, whether the base station detects at least one new neighbor base station during the first time slot of the plurality of time slots. For example, in an aspect cell_1 220 and/or NL manager 250 may include a specially programmed processor module, or a processor executing specially programmed code stored in a memory, to determine whether the base station detects at least one new neighbor base station during the first time slot of the plurality of time slots. In an aspect, the base station (e.g., cell_1 220) and/or NL Manager 250 may include a counter value determining component 270 to perform this function.

For instance, in an aspect, cell_1 220 and/or NL manager 250 may listen (or continue to listen) to transmissions from neighbor base stations (e.g., cells 222, 224, and/or 230) during the first time slot and determine whether the base station (e.g., cell_1 220) receives transmissions from any new base stations (i.e., base stations cell_1 220 is not aware). Cell_1 220 may be aware of neighbor base stations based on its detection in a previous time slot of the current NL mode cycle or a time slot of a previous NL cycle.

In an aspect, at block 340, methodology 300 may include decreasing, at the base station, the value of the counter by one in response to determining that the base station did not detect at least one new neighbor base station during the first time slot of the plurality of time slots. For example, in an aspect cell_1 220 and/or NL manager 250 may include a specially programmed processor module, or a processor executing specially programmed code stored in a memory, to decrease the value of the counter by one in response to determining that the base station (e.g., cell_1 220) did not detect at least one new neighbor base station during the first time slot of the plurality of time slots. For instance, in an aspect, cell_1 220 and/or NL manager 250 may not detect any new neighbor base stations during the first time slot when the cell is in the NL mode. Cell_1 220 may perform the detection using a Network Listen Module or sniffing from transmissions from neighbor base stations and comparing the information (e.g., cell identifier associated with the transmission) with known information to determine whether the base station (e.g., cell_1 220) is aware of the neighbor base station associated with the transmission. In an aspect, the base station (e.g., cell_1 220) and/or NL Manager 250 may include counter value setting component 265 to perform this function. In an additional aspect, the base station (e.g., cell_1 220) and/or NL Manager 250 may include a neighbor detecting component 275 to detect new neighbors of the base station.

In an aspect, at block 350, methodology 300 may include determining, at the base station, whether the value of the counter is zero. For example, in an aspect cell_1 220 and/or NL manager 250 may include a specially programmed processor module, or a processor executing specially programmed code stored in a memory, to determine whether the value of the counter is zero. In an aspect, the base station (e.g., cell_1 220) and/or NL Manager 250 may include counter value determining component 270 to perform this function.

In an aspect, at block 360, methodology 300 may include transmitting, by the base station, during the first time slot when the value of the counter is zero. For example, in an aspect cell_1 220 and/or NL manager 250 may include a specially programmed processor module, or a processor executing specially programmed code stored in a memory, to transmit by the base station a signal during the first time slot when the value of the counter is determined to be zero. That is, when NL manager 250 determines that the value of the counter is zero during the first time slot, the cell transmits. For example, in an aspect, the signal transmitted by the base station may include a reference signal, a data signal, or both. In an aspect, the base station (e.g., cell_1 220) and/or NL Manager 250 may include a transmitting component 280 to perform this function.

As described above, the generation of a random number, setting the counter to the generated random number, and transmitting from the base station when the value of the counter is zero reduces the chance of another base station transmitting during the same time slot and thereby avoiding collisions, and improving detection of neighbor base station transmissions.

In an additional aspect, if cell_1 220 transmitted during the first time slot of the contention window upon determining that the value of the counter is zero, cell_1 220 may just listen (if already listening, continue to listen) to transmissions from other base stations during the remaining time slots of the contention window. This is due to the behavior of a cell in the NL mode as a cell (cell_1 220) may enter the NL mode periodically or occasionally as described above, and generally there is no need for the cell (cell_1 220) to transmit during every time slot of the contention of the window or during multiple time slots of the contention window.

In a further aspect, cell_1 220 and/or NL manager 250 may detect at least one (e.g., one or more) new neighbor base stations during the first time slot of the plurality of time slots. That is, cell_1 220 may detect (e.g., receive) transmission(s) from a new neighbor base station (e.g., cell_2 222, cell_3 224, and/or cell_4 230). In an aspect, a new neighbor base station may be referred to as a base station (or a cell) which was not known by cell_1 220 (e.g., cell_2 222 or cell_4 230 not in the neighbor list of cell_1 220).

Additionally, once cell_1 220 and/or NL manager 250 detects at least one new neighbor base station, cell_1 220 and/or NL manager 250 may generate a second random number during a second time slot at the base station (e.g., second time slot is adjacent to the first time slot in the contention window). In an aspect, the second random number may be generated using the random number generator (e.g., generation of a random number as described above) during the second time slot of the contention window. The second random number may be generated based on the size of the contention window in a manner similar to the generation of the first random number, as described above in reference to block 310. In an aspect, the size of the contention window associated the second time slot may be the same as the size of the contention window in reference to block 310 for generating the first random number.

In an aspect, after generation of the second random number during the second time slot of the contention window at the base station (cell_1 220), cell_1 220 and/or NL manager 250 may set the value of the counter at the base station to the second random number generated during the second time slot. Once cell_1 220 and/or NL sets the counter at cell_1 220 to the second random number, cell_1 220 listens (or continues to listen) for transmissions from other base stations, and NL manager 250 may then determine whether one more new neighbor base stations are detected. This may be achieved by determining the base station identifier of the transmissions detected by cell_1 220. Then, cell_1 220 and/or NL manager 250 decreases the value of the counter by one and determines if the value of the counter is zero.

Additionally, in an aspect, if cell_1 220 and/or NL manager 250 determines that the value of the counter is zero after decreasing the counter by a value of one, cell_1 220 transmits during the second time slot. However, if another cell (e.g., cell_2 222 or cell_3 224) transmits at the same time as cell_1 220, they can detect each other and they restart the counter as described above if the detected cell is a new detection, e.g., one cell that has not detected the other cell previously during the current NL period. In such an instance, a third random number is generated during the third slot of the contention window, the value of the counter is set to the third random number, the value of the counter is reduced by one if no new neighbor base station is detected, and the cell transmits when the counter is determined to zero, and so on.

In an aspect, when a cell (e.g., cell_1 220) fails to detect a new neighbor base stations for a large number of time slots, e.g., 10 cycles, that is, 10×(contention window size=20)=200 ms), cell_1 and/or NL manager 250 may assume that the NL mode has finished.

Additionally, in an aspect, the size of the contention window may be set up by a network operator by configuring the number of time slots in the contention window. For instance, if the size of the contention window is set to a larger value, e.g., 50, when compared to a smaller value, e.g., 20, the probability of collisions in the contention window will be reduced. In a further additional or optional aspect, the size of the contention window may be initially set to a higher value (e.g., size of the contention window set to a value of 50 during the first time slot) and may be decreased (e.g., size of the contention window set to a value of 20) during a later time slot (e.g., second time slot) to reduce the probability of collisions. In an additional or optional aspect, the size of the contention window may be set or configured as a decreasing function of the number of base station already detected by cell_1 220. This is based on the assumption that the probability of collisions may be smaller if larger number of neighbor base stations have already transmitted are have been successfully detected by cell_1 220.

In an additional aspect, for co-channel deployments (or dedicated with multiple operators), the first few slots of a contention window may be used (or reserved) to detect macro cells (e.g., cell_4 230). In such a scenario, during the first few reserved slots, the small cells (e.g., cell_1 220, cell_2 222, and/or cell_3 224) just listen for transmissions from neighbor macro cells and do not transmit.

Although, FIG. 3 is described above in the context of cell_1 220, the other neighbor base stations (cell_2 222, cell_3 224, and/or cell_4 230) may be configured with an instance of NL manager 250 and may perform functions similar to the one described above for implementing the distributed mechanism. As such, the network listen (NL) mode may be improved (or enhanced) by using the back off mechanism described above.

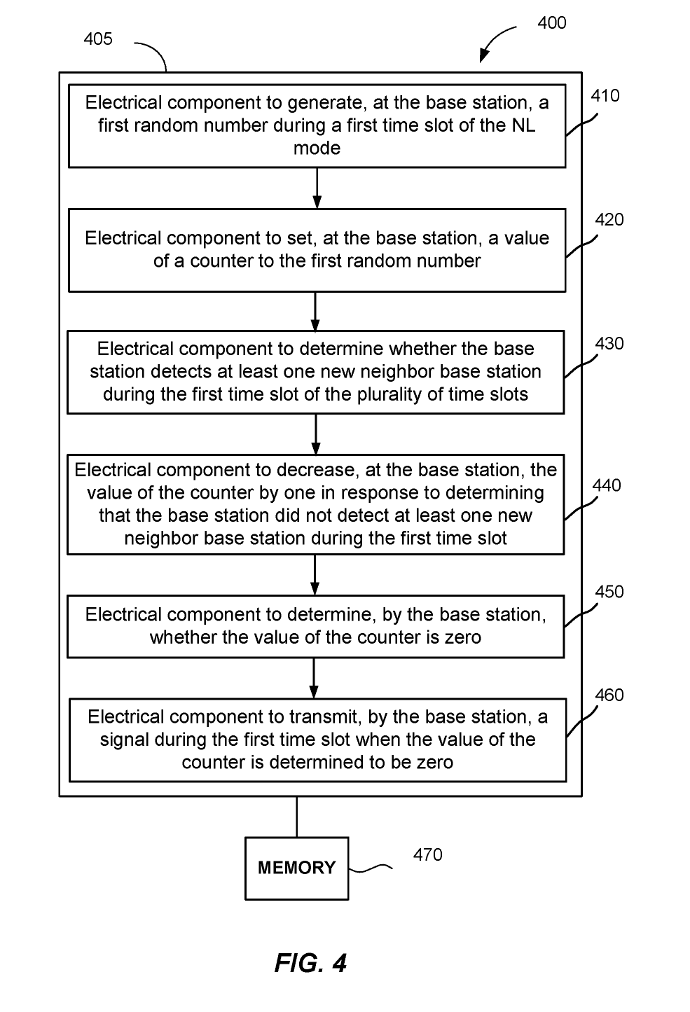

Referring to FIG. 4, an example system 400 is displayed for communicating during a network listen (NL) mode at a base station.

For example, system 400 can reside at least partially within a cell, for example, cells 220, 220, 224, and/or 230 (FIG. 2) and/or NL manager 250 (FIG. 2). It is to be appreciated that system 400 is represented as including functional blocks, which can be functional blocks that represent functions implemented by a processor, software, or combination thereof (for example, firmware). System 400 includes a logical grouping 405 of electrical components that can act in conjunction.

For instance, logical grouping 405 may include an electrical component 410 to generate, at the base station, a first random number during a first time slot of the NL mode, wherein the generation of the first random number is based at least on a size of a contention window which includes a plurality of time slots. For example, in an aspect, electrical component 410 may comprise NL manager 250 and/or random number generating component 260 (FIG. 2).

Additionally, logical grouping 405 may include an electrical component 420 to set, at the base station, a value of a counter to the first random number. For example, in an aspect, electrical component 420 may comprise NL manager 250 and/or counter value setting component 265 (FIG. 2).

Further, logical grouping 405 may include an electrical component 430 to determine, at the base station, whether the base station detects at least one new neighbor base station during the first time slot of the plurality of time slots. For example, in an aspect, electrical component 430 may comprise NL manager 250 and/or neighbor detecting component 275 (FIG. 2).

Furthermore, logical grouping 405 may include an electrical component 440 to decrease, at the base station, the value of the counter by one in response to determining that the base station did not detect at least one new neighbor base station during the first time slot of the plurality of time slots. For example, in an aspect, electrical component 440 may comprise NL manager 250 and/or counter value setting component 265 (FIG. 2).

In addition, logical grouping 405 may include an electrical component 450 to determine, at the base station, whether the value of the counter is zero; and. For example, in an aspect, electrical component 450 may comprise NL manager 250 and/or counter value determining component 270 (FIG. 2).

Further, logical grouping 405 may include an electrical component 460 to transmit, by the base station, a signal during the first time slot when the value of the counter is determined to be zero. For example, in an aspect, electrical component 460 may comprise NL manager 250 and/or transmitting component 280 (FIG. 2).

Additionally, system 400 can include a memory 470 that retains instructions for executing functions associated with the electrical components 410, 420, 430, 440, 450, and/or 460, stores data used or obtained by the electrical components 410, 420, 430, 440, 450, and/or 460, etc. While shown as being external to memory 470, it is to be understood that one or more of the electrical components 410, 420, 430, 440, 450, and/or 460 can exist within memory 470. In one example, electrical components 410, 420, 430, 440, 450, and/or 460 can comprise at least one processor, or each electrical component 410, 420, 430, 440, 450, and/or 460 can be a corresponding module of at least one processor. Moreover, in an additional or alternative example, electrical components 410, 420, 430, 440, 450, and/or 460 can be a computer program product including a computer readable medium, where each electrical component 410, 420, 430, 440, 450, and/or 460 can be corresponding code.

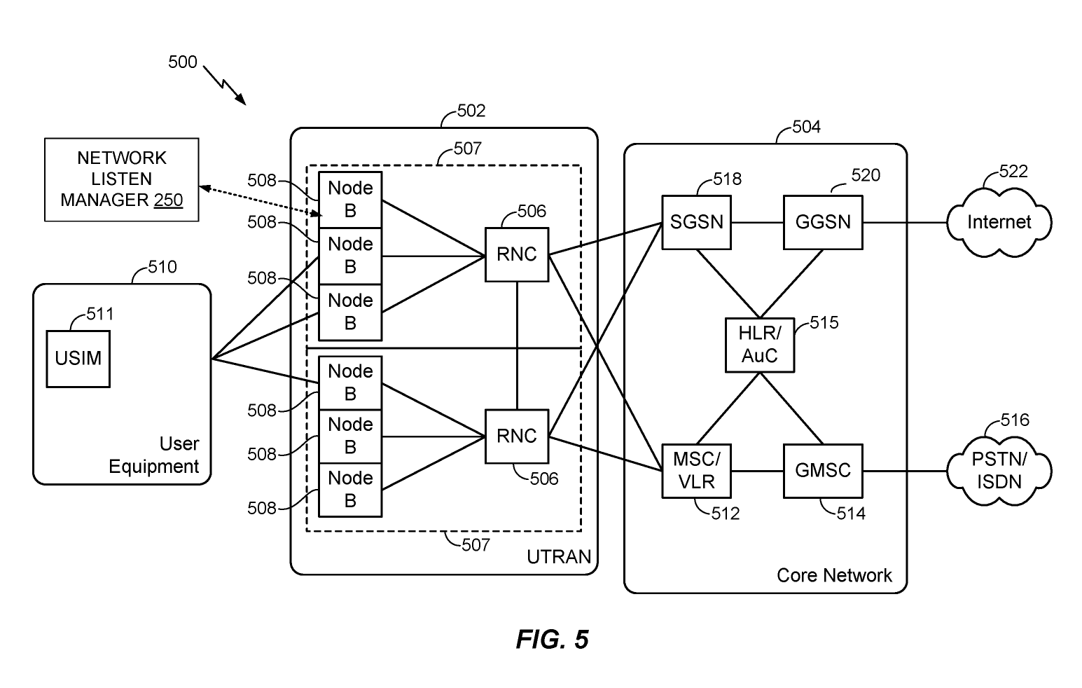

FIG. 5 is a block diagram conceptually illustrating an example of a telecommunications system, including aspects of the system of FIG. 1. By way of example and without limitation, the aspects of the present disclosure illustrated in FIG. 5 are presented with reference to a UMTS system 500 employing a W-CDMA air interface and may include cells 220, 222, 224, and/or 230 executing an aspect of NL manager 250 of FIG. 2. The networks described above that include cells having a NL manager 250 may be part of or may be associated with a system such as UMTS system 500. A UMTS network includes three interacting domains: a Core Network (CN) 504 (which may be an example of the EPC236 of FIG. 2), a UMTS Terrestrial Radio Access Network (UTRAN) 502, and User Equipment (UE) 510 (which may be an example of UE 115 of FIG. 1). In this example, the UTRAN 502 provides various wireless services including telephony, video, data, messaging, broadcasts, and/or other services. The UTRAN 502 may include a plurality of Radio Network Subsystems (RNSs) such as an RNS 507, each controlled by a respective Radio Network Controller (RNC) such as an RNC 506. Here, the UTRAN 502 may include any number of RNCs 506 and RNSs 507 in addition to the RNCs 506 and RNSs 507 illustrated herein. The RNC 506 is an apparatus responsible for, among other things, assigning, reconfiguring and releasing radio resources within the RNS 507. The RNC 506 may be interconnected to other RNCs (not shown) in the UTRAN 502 through various types of interfaces such as a direct physical connection, a virtual network, or the like, using any suitable transport network.

Communication between a UE 510 and a NodeB 508 may be considered as including a physical (PHY) layer and a medium access control (MAC) layer. Further, communication between a UE 510 and an RNC 506 by way of a respective NodeB 508 may be considered as including a radio resource control (RRC) layer. In the instant specification, the PHY layer may be considered layer 1; the MAC layer may be considered layer 2; and the RRC layer may be considered layer 3. Information herein below utilizes terminology introduced in Radio Resource Control (RRC) Protocol Specification, 3GPP TS 25.331 v9.1.0, incorporated herein by reference.

The geographic region covered by the SRNS 507 may be divided into a number of cells, with a radio transceiver apparatus serving each cell. A radio transceiver apparatus is commonly referred to as a NodeB in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three NodeBs 508 are shown in each SRNS 507; however, the SRNSs 507 may include any number of wireless NodeBs. The NodeBs 508 provide wireless access points to a core network (CN) 504 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. In a UMTS system, the UE 510 may further include a universal subscriber identity module (USIM) 511, which contains a user's subscription information to a network. For illustrative purposes, one UE 510 is shown in communication with a number of the NodeBs 208. The downlink (DL), also called the forward link, refers to the communication link from a NodeB 508 to a UE 510, and the uplink (UL), also called the reverse link, refers to the communication link from a UE 510 to a NodeB 508.

The core network 504 interfaces with one or more access networks, such as the UTRAN 502. As shown, the core network 504 is a GSM core network. However, as those skilled in the art will recognize, the various concepts presented throughout this disclosure may be implemented in a RAN, or other suitable access network, to provide UEs with access to types of core networks other than GSM networks.

The core network 504 includes a circuit-switched (CS) domain and a packet-switched (PS) domain. Some of the circuit-switched elements are a Mobile services Switching Centre (MSC), a Visitor location register (VLR) and a Gateway MSC. Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains. In the illustrated example, the core network 504 supports circuit-switched services with a MSC 512 and a GMSC 514. In some applications, the GMSC 514 may be referred to as a media gateway (MGW). One or more RNCs, such as the RNC 506, may be connected to the MSC 512. The MSC 512 is an apparatus that controls call setup, call routing, and UE mobility functions. The MSC 512 also includes a visitor location register (VLR) that contains subscriber-related information for the duration that a UE is in the coverage area of the MSC 512. The GMSC 514 provides a gateway through the MSC 512 for the UE to access a circuit-switched network 516. The core network 504 includes a home location register (HLR) 515 containing subscriber data, such as the data reflecting the details of the services to which a particular user has subscribed. The HLR is also associated with an authentication center (AuC) that contains subscriber-specific authentication data. When a call is received for a particular UE, the GMSC 514 queries the HLR 515 to determine the UE's location and forwards the call to the particular MSC serving that location.

The core network 504 also supports packet-data services with a serving GPRS support node (SGSN) 518 and a gateway GPRS support node (GGSN) 520. GPRS, which stands for General Packet Radio Service, is designed to provide packet-data services at speeds higher than those available with standard circuit-switched data services. The GGSN 520 provides a connection for the UTRAN 502 to a packet-based network 522. The packet-based network 522 may be the Internet, a private data network, or some other suitable packet-based network. The primary function of the GGSN 520 is to provide the UEs 510 with packet-based network connectivity. Data packets may be transferred between the GGSN 520 and the UEs 510 through the SGSN 518, which performs primarily the same functions in the packet-based domain as the MSC 512 performs in the circuit-switched domain.

The UMTS air interface is a spread spectrum Direct-Sequence Code Division Multiple Access (DS-CDMA) system. The spread spectrum DS-CDMA spreads user data through multiplication by a sequence of pseudorandom bits called chips. The W-CDMA air interface for UMTS is based on such direct sequence spread spectrum technology and additionally calls for a frequency division duplexing (FDD). FDD uses a different carrier frequency for the uplink (UL) and downlink (DL) between a NodeB 508 and a UE 510. Another air interface for UMTS that utilizes DS-CDMA, and uses time division duplexing, is the TD-SCDMA air interface. Those skilled in the art will recognize that although various examples described herein may refer to a WCDMA air interface, the underlying principles are equally applicable to a TD-SCDMA air interface.

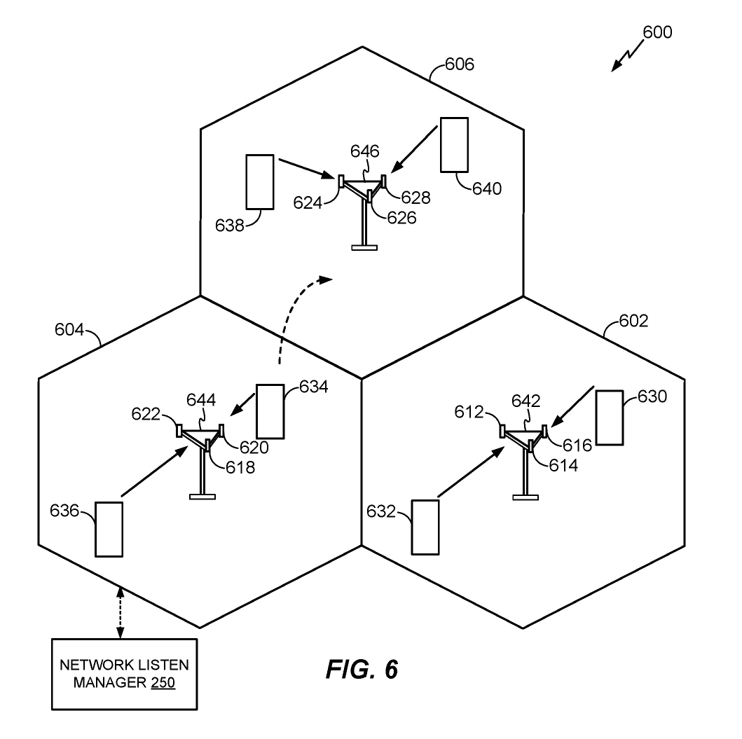

Referring to FIG. 6, an access network 600 in UTRAN architecture is illustrated, and may include cells 602, 604, and 606, which be the same as or similar to cells 220, 222, 224, and/or 230 (FIG. 2) in that they are configured to include NL manager 250 (FIG. 2; for example, illustrated here as being associated with cell 604) for transmitting during a network listen (NL) mode at a base station. The multiple sectors can be formed by groups of antennas with each antenna responsible for communication with UEs in a portion of the cell. For example, in cell 602, antenna groups 612, 614, and 616 may each correspond to a different sector. In cell 604, antenna groups 618, 620, and 622 each correspond to a different sector. In cell 606, antenna groups 624, 626, and 628 each correspond to a different sector. The cells 602, 604 and 606 may include several wireless communication devices, e.g., User Equipment or UEs, which may be in communication with one or more sectors of each cell 602, 604 or 606. For example, UEs 630 and 632 may be in communication with NodeB 642, UEs 634 and 636 may be in communication with NodeB 644, and UEs 638 and 640 can be in communication with NodeB 646. Here, each NodeB 642, 644, 646 is configured to provide an access point to a CN 504 (see FIG. 5) for all the UEs 630, 632, 634, 636, 638, 640 in the respective cells 602, 604, and 606. UEs 630, 632, 634, 636, 638, and 640 may be similar to UE 115, described above, and NodeBs 642, 644, and/or 646 can correspond to one or more of the macro cells and/or small cells described in, for example, FIGS. 1-2.

As the UE 634 moves from the illustrated location in cell 604 into cell 606, a serving cell change (SCC) or handover may occur in which communication with the UE 634 transitions from the cell 604, which may be referred to as the source cell, to cell 606, which may be referred to as the target cell. Management of the handover procedure may take place at the UE 634, at the NodeBs corresponding to the respective cells, at a radio network controller 206 (see FIG. 5), or at another suitable node in the wireless network. For example, during a call with the source cell 604, or at any other time, the UE 634 may monitor various parameters of the source cell 604 as well as various parameters of neighboring cells such as cells 606 and 602. Further, depending on the quality of these parameters, the UE 634 may maintain communication with one or more of the neighboring cells. During this time, the UE 634 may maintain an Active Set, that is, a list of cells that the UE 634 is simultaneously connected to (i.e., the UTRA cells that are currently assigning a downlink dedicated physical channel (DPCH) or fractional downlink dedicated physical channel (F-DPCH) to the UE 634 may constitute the Active Set).

The modulation and multiple access scheme employed by the access network 800 may vary depending on the particular telecommunications standard being deployed. By way of example, the standard may include Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. The standard may alternately be Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), and Flash-OFDM employing OFDMA. UTRA, E-UTRA, UMTS, LTE, LTE Advanced, and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

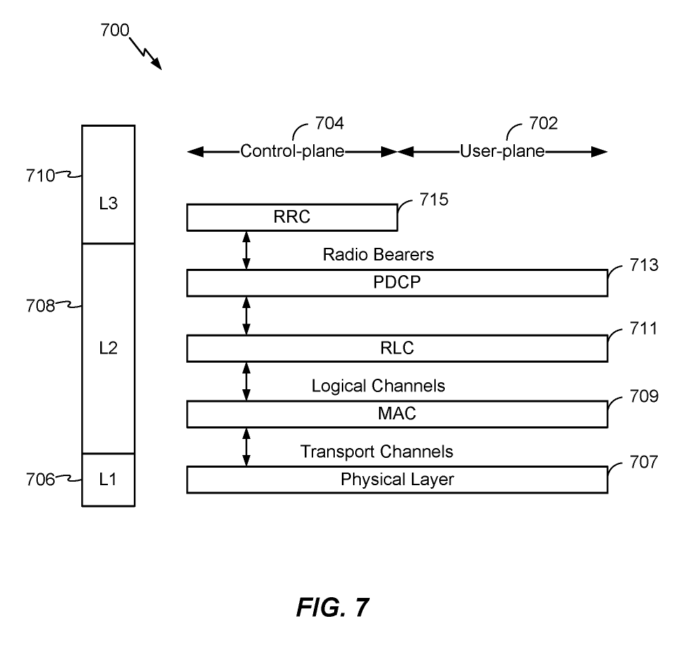

The radio protocol architecture may take on various forms depending on the particular application. An example for an HSPA system is presented below with reference to FIG. 7.

FIG. 7 is a conceptual diagram illustrating an example of the radio protocol architecture 700 for the user plane 702 and the control plane 704 of a user equipment (UE) or NodeB/base station. The architecture 700 may be used with the networks described herein that include small cells having a NL manager 250. For example, architecture 700 may be included in a network entity and/or UE such as the ones described in FIGS. 1-4. The radio protocol architecture 700 for the UE and NodeB is shown with three layers: Layer 1 706, Layer 2 708, and Layer 3 710. Layer 1 706 is the lowest lower and implements various physical layer signal processing functions. As such, Layer 1 706 includes the physical layer 707. Layer 2 (L2 layer) 708 is above the physical layer 707 and is responsible for the link between the UE and NodeB over the physical layer 707. Layer 3 (L3 layer) 710 includes a radio resource control (RRC) sublayer 715. The RRC sublayer 715 handles the control plane signaling of Layer 3 between the UE and the UTRAN.

In the user plane, the L2 layer 708 includes a media access control (MAC) sublayer 709, a radio link control (RLC) sublayer 711, and a packet data convergence protocol (PDCP) 713 sublayer, which are terminated at the NodeB on the network side. Although not shown, the UE may have several upper layers above the L2 layer 708 including a network layer (e.g., IP layer) that is terminated at a PDN gateway on the network side, and an application layer that is terminated at the other end of the connection (e.g., far end UE, server, etc.).

The PDCP sublayer 713 provides multiplexing between different radio bearers and logical channels. The PDCP sublayer 713 also provides header compression for upper layer data packets to reduce radio transmission overhead, security by ciphering the data packets, and handover support for UEs between NodeBs. The RLC sublayer 711 provides segmentation and reassembly of upper layer data packets, retransmission of lost data packets, and reordering of data packets to compensate for out-of-order reception due to hybrid automatic repeat request (HARQ). The MAC sublayer 709 provides multiplexing between logical and transport channels. The MAC sublayer 709 is also responsible for allocating the various radio resources (e.g., resource blocks) in one cell among the UEs. The MAC sublayer 709 is also responsible for HARQ operations.

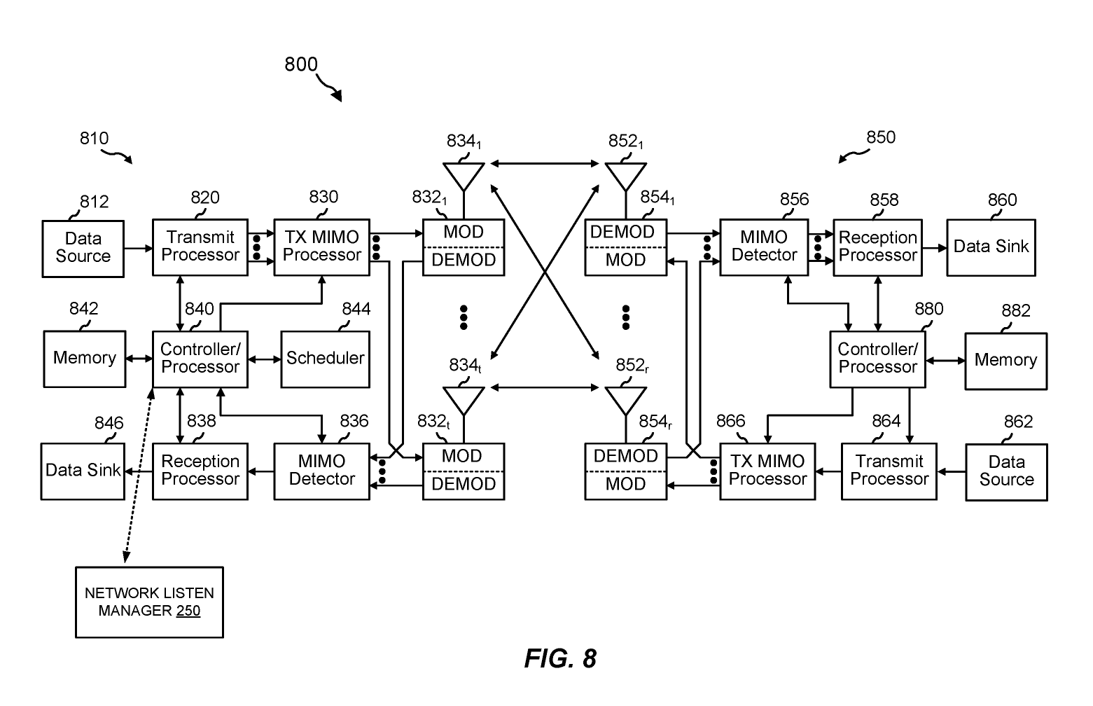

FIG. 8 is a block diagram 800 conceptually illustrating examples of an eNodeB 810 and a UE 850 configured in accordance with an aspect of the present disclosure, wherein the eNodeB may be cell_1 220, cell_2 222, cell_3 224, or cell_4 230 of FIG. 2 that is configured to include NL manager 250. For example, the base station/eNodeB 810 and the UE 850 of a system 800, as shown in FIG. 8, may be one of the base stations/eNodeBs and one of the UEs in FIGS. 1-4. The base station 810 may be equipped with antennas 834₁₋ₜ, and the UE 850 may be equipped with antennas 852₁₋ᵣ, wherein t and r are integers greater than or equal to one.

At the base station 810, a base station transmit processor 820 may receive data from a base station data source 812 and control information from a base station controller/processor 840. The control information may be carried on the PBCH, PCFICH, PHICH, PDCCH, etc. The data may be carried on the PDSCH, etc. The base station transmit processor 820 may process (e.g., encode and symbol map) the data and control information to obtain data symbols and control symbols, respectively. The base station transmit processor 820 may also generate reference symbols, e.g., for the PSS, SSS, and cell-specific reference signal (RS). A base station transmit (TX) multiple-input multiple-output (MIMO) processor 830 may perform spatial processing (e.g., precoding) on the data symbols, the control symbols, and/or the reference symbols, if applicable, and may provide output symbol streams to the base station modulators/demodulators (MODs/DEMODs) 832₁₋ₜ. Each base station modulator/demodulator 832 may process a respective output symbol stream (e.g., for OFDM, etc.) to obtain an output sample stream. Each base station modulator/demodulator 832 may further process (e.g., convert to analog, amplify, filter, and upconvert) the output sample stream to obtain a downlink signal. Downlink signals from modulators/demodulators 832₁₋ₜ may be transmitted via the antennas 834₁₋ₜ, respectively.

At the UE 850, the UE antennas 852₁₋ᵣ may receive the downlink signals from the base station 810 and may provide received signals to the UE modulators/demodulators (MODs/DEMODs) 854₁₋ᵣ respectively. Each UE modulator/demodulator 854 may condition (e.g., filter, amplify, downconvert, and digitize) a respective received signal to obtain input samples. Each UE modulator/demodulator 854 may further process the input samples (e.g., for OFDM, etc.) to obtain received symbols. A UE MIMO detector 856 may obtain received symbols from all the UE modulators/demodulators 854₁₋ᵣ, and perform MIMO detection on the received symbols if applicable, and provide detected symbols. A UE reception processor 858 may process (e.g., demodulate, interleave, and decode) the detected symbols, provide decoded data for the UE 850 to a UE data sink 860, and provide decoded control information to a UE controller/processor 880.

On the uplink, at the UE 850, a UE transmit processor 864 may receive and process data (e.g., for the PUSCH) from a UE data source 862 and control information (e.g., for the PUCCH) from the UE controller/processor 880. The UE transmit processor 864 may also generate reference symbols for a reference signal. The symbols from the UE transmit processor 864 may be precoded by a UE TX MIMO processor 866 if applicable, further processed by the UE modulator/demodulators 854₁₋ᵣ (e.g., for SC-FDM, etc.), and transmitted to the base station 810. At the base station 810, the uplink signals from the UE 850 may be received by the base station antennas 834, processed by the base station modulators/demodulators 832, detected by a base station MIMO detector 836 if applicable, and further processed by a base station reception processor 838 to obtain decoded data and control information sent by the UE 850. The base station reception processor 338 may provide the decoded data to a base station data sink 846 and the decoded control information to the base station controller/processor 840.

The base station controller/processor 840 and the UE controller/processor 880 may direct the operation at the base station 810 and the UE 850, respectively. The base station controller/processor 840 and/or other processors and modules at the base station 810 may perform or direct, e.g., the execution of the functional blocks illustrated in FIG. 4, various processes for the techniques described herein (e.g., flowchart illustrated in FIG. 3). The base station memory 842 and the UE memory 882 may store data and program codes for the base station 810 and the UE 850, respectively. A scheduler 844 may be used to schedule UE 850 for data transmission on the downlink and/or uplink.

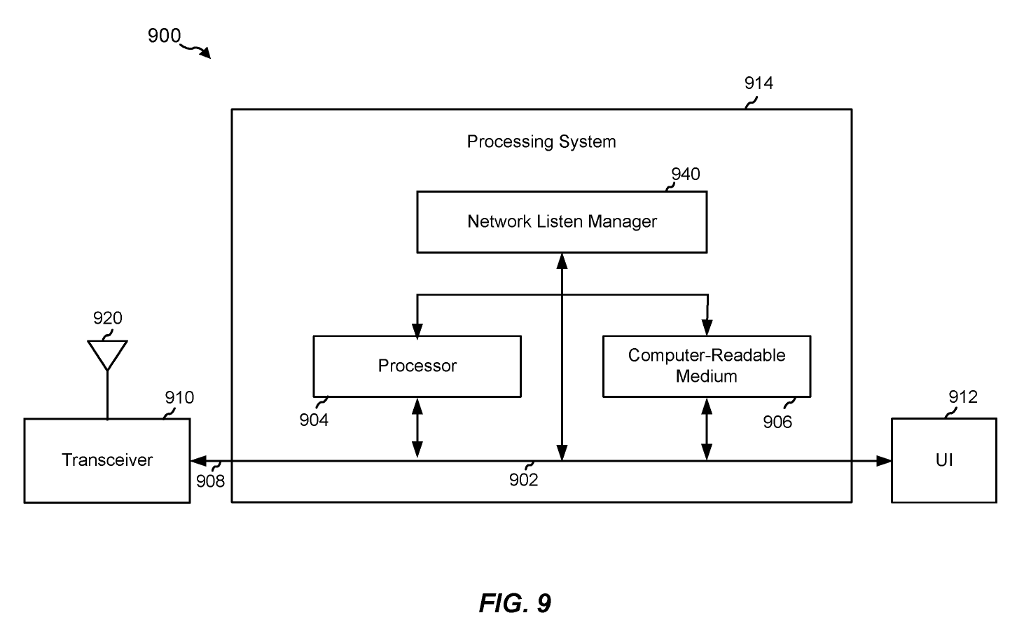

FIG. 9 is a block diagram conceptually illustrating an example hardware implementation for an apparatus 900 employing a processing system 914 configured in accordance with an aspect of the present disclosure. The processing system 914 includes a NL manager 940 that may be an example of the NL manager 250 of FIG. 2. In one example, the apparatus 900 may be the same or similar, or may be included with one of the eNodeBs of FIGS. 1-2. In this example, the processing system 914 may be implemented with a bus architecture, represented generally by the bus 902. The bus 902 may include any number of interconnecting buses and bridges depending on the specific application of the processing system 914 and the overall design constraints. The bus 902 links together various circuits including one or more processors (e.g., central processing units (CPUs), microcontrollers, application specific integrated circuits (ASICs), field programmable gate arrays (FPGAs)) represented generally by the processor 904, and computer-readable media, represented generally by the computer-readable medium 906. The bus 902 may also link various other circuits such as timing sources, peripherals, voltage regulators, and power management circuits, which are well known in the art, and therefore, will not be described any further. A bus interface 908 provides an interface between the bus 902 and a transceiver 910, which is connected to one or more antennas 920 for receiving or transmitting signals. The transceiver 910 and the one or more antennas 920 provide a mechanism for communicating with various other apparatus over a transmission medium (e.g., over-the-air). Depending upon the nature of the apparatus, a user interface (UI) 912 (e.g., keypad, display, speaker, microphone, joystick) may also be provided.

The processor 904 is responsible for managing the bus 902 and general processing, including the execution of software stored on the computer-readable medium 906. The software, when executed by the processor 904, causes the processing system 914 to perform the various functions described herein for any particular apparatus (e.g., NL manager 270, cells 240 and 250). The computer-readable medium 906 may also be used for storing data that is manipulated by the processor 904 when executing software. The NL manager 940 as described above may be implemented in whole or in part by processor 904, or by computer-readable medium 906, or by any combination of processor 904 and computer-readable medium 906.

The various concepts presented throughout this disclosure may be implemented across a broad variety of telecommunication systems, network architectures, and communication standards.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method for communicating during a network listen (NL) mode at a base station, comprising:
generating, at the base station, a first random number during a first time slot of the NL mode, wherein the generation of the first random number is based at least on a size of a contention window which includes a plurality of time slots;
setting, at the base station, a value of a counter to the first random number;
determining, at the base station, whether the base station detects at least one new neighbor base station during the first time slot of the plurality of time slots;
decreasing, at the base station, the value of the counter by one in response to determining that the base station did not detect at least one new neighbor base station during the first time slot of the plurality of time slots;
determining, at the base station, whether the value of the counter is zero; and
transmitting, by the base station, a signal during the first time slot when the value of the counter is determined to be zero.

2. The method of claim 1, further comprising:
listening, by the base station, during one or more remaining time slots of the contention window after transmission by the base station.

3. The method of claim 1, further comprising:
detecting, by the base station, at least one new neighbor base station during the first time slot of the plurality of time slots; and
generating, at the base station, a second random number during a second time slot in response to determining that the base station detected at least one new neighbor base station during the first time slot of the plurality of time slots, wherein the generation of the second random number is based at least on the size of the contention window.

4. The method of claim 3, further comprising:
setting, at the base station, the value of the counter to the second random number;
determining, at the base station, whether the base station detects at least one new neighbor base station during the second time slot of the plurality of time slots;
decreasing, at the base station, the value of the counter by one in response to determining that the base station did not detect at least one new neighbor base station during the second time slot of the plurality of time slots;
determining, at the base station, whether the value of the counter is zero; and
transmitting, by the base station, the signal during the second time slot when the value of the counter is determined to be zero.

5. The method of claim 4, further comprising:
repeating, at the base station, one or more of generating the second random number, setting the value of the counter to the generated second random number, determining whether the base station detects at least one new neighbor base station, decreasing the value of the counter, or determining whether the value of the counter is zero until transmission by the base station.

6. The method of claim 1, wherein the size of the contention window or a duration of each of the plurality of time slots is configured by a network operator.

7. The method of claim 1, further comprising:
setting, at the base station, the size of the contention window to a higher value at beginning of the NL mode; and
decreasing, at the base station, the size of the contention window as a function of a number of neighbor base stations detected.

8. The method of claim 1, wherein the base station enters the NL mode upon initial setup of the base station.

9. An apparatus for communicating during a network listen (NL) mode at a base station, comprising:
means for generating, at the base station, a first random number during a first time slot of the NL mode, wherein the generation of the first random number is based at least on a size of a contention window which includes a plurality of time slots;
means for setting, at the base station, a value of a counter to the first random number;
means for determining, at the base station, whether detects at least one new neighbor base station during the first time slot of the plurality of time slots;
means for decreasing, at the base station, the value of the counter by one in response to determining that the base station did not detect at least one new neighbor base station during the first time slot of the plurality of time slots;
means for determining, at the base station, whether the value of the counter is zero; and
means for transmitting, by the base station, a signal during the first time slot when the value of the counter is determined to be zero.

10. The apparatus of claim 9, further comprising:
means for listening, by the base station, during one or more remaining time slots of the contention window after transmission by the base station.

11. The apparatus of claim 9, further comprising:
means for detecting, by the base station, at least one new neighbor base station during the first time slot of the plurality of time slots; and
means for generating, at the base station, a second random number during a second time slot in response to determining that the base station detected at least one new neighbor base station during the first time slot of the plurality of time slots, wherein the generation of the second random number is based at least on the size of the contention window.

12. The apparatus of claim 11, further comprising:
means for setting, at the base station, the value of the counter at the base station to the second random number;
means for determining, at the base station, whether the base station detects at least one new neighbor base station during the second time slot of the plurality of time slots;
means for decreasing, at the base station, the value of the counter by one in response to determining that the base station did not detect at least one new neighbor base station during the second time slot of the plurality of time slots;
means for determining, at the base station, whether the value of the counter is zero; and
means for transmitting, by the base station, the signal during the second time slot when the value of the counter is determined to be zero.

13. The apparatus of claim 12, further comprising:
means for repeating, at the base station, one or more of generating, the second random number, setting the value of the counter to the generated second random number, determining whether the base station detects at least one new neighbor base station, decreasing the value of the counter, or determining whether the value of the counter is zero until transmission by the base station.

14. The apparatus of claim 9, wherein the size of the contention window or a duration of each of the plurality of time slots is configured by a network operator.

15. The apparatus of claim 9, further comprising:
means for setting, at the base station, the size of the contention window to a higher value at beginning of the NL mode at the base station; and
means for decreasing, at the base station, the size of the contention window as a function of a number of neighbor base stations detected.

16. The apparatus of claim 9, wherein the base station enters the NL mode upon initial setup of the base station.

17. A non-transitory computer readable medium storing computer executable code for communicating during a network listen (NL) mode at a base station, comprising:
code for generating, at the base station, a first random number during a first time slot of the NL mode at the base station, wherein the generation of the first random number is based at least on a size of a contention window which includes a plurality of time slots;
code for setting, at the base station, a value of a counter to the first random number;
code for determining, at the base station, whether the base station detects at least one new neighbor base station during the first time slot of the plurality of time slots;
code for decreasing, at the base station, the value of the counter by one in response to determining that the base station did not detect at least one new neighbor base station during the first time slot of the plurality of time slots;
code for determining, at the base station, whether the value of the counter is zero; and
code for transmitting, by the base station, a signal during the first time slot when the value of the counter is determined to be zero.

18. The computer readable medium of claim 17, further comprising:
code for listening by the base station during one or more remaining time slots of the contention window after transmission by the base station.

19. The computer readable medium of claim 17, further comprising:
code for detecting, by the base station, at least one new neighbor base station during the first time slot of the plurality of time slots; and
code for generating, at the base station, a second random number during a second time slot at the base station in response to determining that the base station detected at least one new neighbor base station during the first time slot of the plurality of time slots, wherein the generation of the second random number is based at least on the size of the contention window.

20. The computer readable medium of claim 19, further comprising:
code for setting, at the base station, the value of the counter at the base station to the second random number;
code for determining, at the base station, whether the base station detects at least one new neighbor base station during the second time slot of the plurality of time slots;
code for decreasing, at the base station, the value of the counter by one in response to determining that the base station did not detect at least one new neighbor base station during the second time slot of the plurality of time slots;
code for determining, at the base station, whether the value of the counter is zero; and
code for transmitting, by the base station, the signal during the second time slot when the value of the counter is determined to be zero.

21. The computer readable medium of claim 20, further comprising:
code for repeating, at the base station, one or more of generating the second random number, setting the value of the counter to the generated second random number, determining whether the base station detects at least one new neighbor base station, decreasing the value of the counter, or determining whether the value of the counter is zero until transmission by the base station.

22. The computer readable medium of claim 17, wherein the size of the contention window or a duration of each of the plurality of time slots is configured by a network operator.

23. The computer readable medium of claim 17, further comprising:
code for setting, at the base station, the size of the contention window to a higher value at beginning of the NL mode; and
code for decreasing, at the base station, the size of the contention window as a function of a number of neighbor base stations detected.

24. The computer readable medium of claim 17, wherein the base station enters the NL mode upon initial setup of the base station.

25. A base station for communicating during a network listen (NL) mode, comprising:
a memory configured to store data; and
one or more processors communicatively coupled with the memory, wherein the one or more processors and the memory are configured to:
generate, at the base station, a first random number during a first time slot of the NL mode at the base station, wherein the generation of the first random number is based at least on a size of a contention window which includes a plurality of time slots at the base station;
set, at the base station, a value of a counter at the base station to the first random number;
determine, at the base station, whether the base station detects at least one new neighbor base station during the first time slot of the plurality of time slots;
decrease, at the base station, the value of the counter by one in response to determining that the base station did not detect at least one new neighbor base station during the first time slot of the plurality of time slots;
determine, at the base station, whether the value of the counter is zero; and
transmit, by the base station, a signal during the first time slot when the value of the counter is determined to be zero.

26. The base station of claim 25, wherein the one or more processors and the memory are further configured to:
listen by the base station during one or more remaining time slots of the contention window after transmission by the base station.

27. The base station of claim 25, wherein the one or more processors and the memory are further configured to:
detect, by the base station, at least one new neighbor base station during the first time slot of the plurality of time slots; and
generate, at the base station, a second random number during a second time slot in response to determining that the base station detected at least one new neighbor base station during the first time slot of the plurality of time slots, wherein the generation of the second random number is based at least on the size of the contention window.

28. The base station of claim 27, wherein the one or more processors and the memory are further configured to:
set, at the base station, the value of the counter at the base station to the second random number;
determine, at the base station, whether the base station detects at least one new neighbor base station during the second time slot of the plurality of time slots;
decrease, at the base station, the value of the counter by one in response to determining that the base station did not detect at least one new neighbor base station during the second time slot of the plurality of time slots;
determine, at the base station, whether the value of the counter is zero; and
transmit, by the base station, the signal during the second time slot when the value of the counter is determined to be zero.

29. The base station of claim 28, wherein the one or more processors and the memory are further configured to:
repeat, at the base station, one or more of generating the second random number, the setting the value of the counter to the generated second random number, determining whether the base station detects at least one new neighbor base station, decreasing the value of the counter, or determining whether the value of the counter is zero until transmission by the base station.

30. The base station of claim 25, wherein the size of the contention window or a duration of each of the plurality of time slots is configured by a network operator.
